(19) United States
(12) Patent Application Publication
(10) Pub. No.: US 2016/0213959 A1
(43) Pub. Date: Jul. 28, 2016

(54) Protective Garment

(71) Applicant: Christopher S. Barklow, Oakland, CA (US)

(72) Inventor: Christopher S. Barklow, Oakland, CA (US)

(73) Assignee: SKOTTI LLC, Emeryville, CA (US)

(21) Appl. No.: 14/955,029

(22) Filed: Nov. 30, 2015

Related U.S. Application Data
(60) Provisional application No. 62/085,422, filed on Nov. 28, 2014.

(51) Int. Cl. A62B 23/02; A41D 13/11; A62B 18/02

(52) U.S. Cl. CPC A62B 23/025; A62B 18/02; A41D 13/1107

(57) ABSTRACT

A rapidly deploying respiratory protective garment to protect from particles, gases, odors, and also weather elements; having an inner panel constructed of protective devices and a fashionable garment outer panel concealing the devices within. Assembled at the inner panel made of stretch fabric are an outer filter and inner filter made of non-stretch fabric that are combined to form a pocket. Specialized middle filters and/or a filter frame can be inserted into or removed from the pocket. A pre-formed nose clip and nose pad are attached to a projection at the nose area. A chin seal or chin filter is attached to a projection at the chin area. The nose and chin projections are formed by fabric darts, which outwardly project the inner panel and filters to form breathing space. Concealing the devices of the inner panel, outer panel embodiments include a sport, tube, cowl, rectangular, and infinity scarf.

### CROSS-REFERENCE TO RELATED APPLICATION

This application claims the benefit of U.S. Provisional Application No. 62085422, filed Nov. 28, 2014.

### BACKGROUND OF THE INVENTION

1. Field of the Invention

The present invention relates generally to the field of protective respiratory masks and more particularly to masks adapted to or contained within a garment. Specifically, the invention relates to a rapidly deploying and fashionably acceptable respiratory protective garment that may also protect the head, face, and neck from weather elements.

2. Description of the Related Art

Present art that offers some respiratory protection does not perform as well as conventional face masks. A filter or mask affixed to a garment alone will not provide effective respiratory protection without sufficient breathing space, filter surface area, and mechanisms to seal the filter around the nose and mouth region.

A protective garment which does not seal the gaps between the nose and cheekbones will allow contaminated air to easily bypass the filter, especially when the wearer inhales. Garments that do possess a bendable device, such as a wire, to shape a filter to form a seal between the nose and cheekbones, require the device to be re-formed with each donning of the garment. This is often not done due to the general public not being accustomed to wearing respiratory protection, and therefore do not have the presence of mind to re-form the wire each time the garment in applied, compromising protection.

Filters that are placed against the nose and mouth provide minimal effective surface area of the filter. Also, there is no added protection of flying objects, such as insects and debris, from impacting the nose and mouth when participating in high speed activities such as riding a motorcycle, bicycle, or off-road vehicle.

Dust masks commonly found in hardware stores can help prevent dust from irritating the respiratory system, and “surgical” masks readily available at drug stores are intended to prevent bodily fluid contamination. These devices are not intended nor are they effective at protecting the wearer from odors and chemicals in the air, such as caused by motor vehicle and factory emissions and cigarette smoke. Although more aesthetically pleasing, the aforementioned masks are equally ineffective when adapted or affixed to an article of clothing.

Protective garments must have some means of tension and/or mechanism(s) to comfortably hold the filter portion up and in place over the nose and mouth region. Products without such devices fail to hold in place, or must be secured uncomfortably tight and may still fall down during periods of activity, failing to provide protection.

Furthermore, protective garments without a mechanism to secure the filter portion, so that the filter portion remains positioned over the nose and mouth region, may rotate or shift with the movement and activity of the wearer. The wearer may be unable to detect the filter portion is no longer correctly positioned over the nose and mouth region and protection compromised.

Present art respiratory masks and protective garments that incorporate a mask require time consuming steps to secure the mask in place, which can include: retrieving the mask or garment from a pocket, purse, or bag; locating and centering the filter portion over the nose and mouth; securing ear loops, which can snag and get tangled in the wearers hair in the process of donning the article; locating and tying straps at the back of the head and neck; and pressing and forming nose bands or wires. Once the mask or garment is removed, the process must start over with each subsequent application. While this is acceptable in predictable pollution environments, such as when donning personal protective equipment (PPE) prior to entering a laboratory or surgical room, masks or garments that incorporate a mask are not suitable in unpredictable pollution environments, when the hazard or irritant may appear without warning.

Unlike professional environments and tasks in which exposure to hazards and irritants is typically predictable, the majority of the public cannot predictably know when particles, germs, or gases that irritate the individual will appear, such as exhaust fumes, a sick person coughing or sneezing, perfume or cigarette smoke, and the like. There is a public need for a rapidly deploying protective garment that can be positioned in a single step.

Protective garments, which outwardly display hardware and other implements such as ear loops, tie straps, nose clips, elastic bands, and gathered or folded fabric, are conspicuous and may envision the appearance of a protective mask. Lack of use of respiratory protection by the general public can be attributed to many people considering the wearing of such conspicuous garments to be publicly or fashionably unacceptable.

Some protective garments possessing a filter or filters illustrate an attempt to eliminate unsightly devices of construction commonly associated with protective masks, such as ear loops that center and hold a filter in place. Such garments that lack an indexing element to identify the center of the filter portion, cause the wearer to be unable to confidently locate and center the filter over the nose and mouth when donning the garment, which may result with the filter improperly positioned.

A protective garment formed by use of a rigid frame, an inserted pre-formed mask, or by gathering or pleating fabric in a manner to form and maintain shape, can be bulky and uncomfortable when lowered to below the chin; and will limit the wearers ability to further compress the garment down around the neck when not needed but desired to be kept readily available.

Protective garments made mostly, or entirely of non-stretch or woven fabric do not conform well to the contours and movement of the head, face, and neck and fall easily during periods of activity, requiring the wearer to tighten the garment to the point of discomfort, which often leads to soreness, for example at the bridge of the nose.

Other devices to overcome the tendency of the protective garment to fall down, such as an elastic band along the upper edge of the garment, ear loops, or rigid media that push, rub, or pinch the skin, also cause discomfort to the wearer, which leads the wearer to remove the garment to give relief to sore areas, even when protection would continue to be warranted.

Without mechanisms in the design of the protective garment to provide breathing space, the garment rests against the nose and mouth. This reduces the filtering surface area, and causes saliva and moisture from the wearer's breath to collect on the fabric and be continuously in contact with the mouth.

Persons in workplace environments have specific periods and places of when to wear and remove respiratory protection, and these masks are not necessarily designed to be comfortable enough for casual wear, or to wear for extended periods. These masks are equally uncomfortable when adapted or affixed to an article of clothing.

Natural gaps are formed between the nose and cheekbones when the upper edge of a protective garment is placed across the bridge of the nose by the wearer. If no mechanisms are in place to seal the gaps, fogging of glasses will occur as the wearer exhales, especially during periods of high activity. This leads the wearer to remove the garment in order to see clearly, even when protection would continue to be warranted.

Protective masks constructed for maximum protection and/or made of tightly woven material, make breathing difficult and also accumulate moisture and heat inside the mask. These masks are designed as personal protective equipment (PPE) for specific situations where a high level of protection is needed. When these masks are used for general purposes not specified to the PPE, often the wearer removes the mask or lowers it below the nose due to discomfort, thereby compromising protection.

What is needed therefore is a socially acceptable protective garment that is effective, comfortable, and adaptable to the activities and needs of the public.

### SUMMARY OF THE INVENTION

The protective garment of the present invention overcomes the deficiencies of the prior art by providing the technical performance benefits of a respiratory protective device in garment form, which can also provide protection from weather elements. The protective garment contains within mechanisms: to contain respiratory protective filters; to remove or replace protective filters; to secure the respiratory portion over the nose and mouth; to seal gaps at the areas around the nose and mouth; to form breathing and talking space; to retain the respiratory portion in the on or up position; to rapidly deploy, doff, and re-deploy; and to cover the face and neck. The protective garment is comfortable when worn for protection and also when placed in the doff position. The respiratory portion of the protective garment is not firm or rigid and is able to fold and compress to be worn down around the neck. Other mechanisms, such as an exhalation valve or head cover, could be added to the features and benefits contained within.

In the preferred embodiment, a garment outer panel conceals from view a constructed inner panel, which contains within the technical features and benefits of a respiratory protective device. There is no outward appearance of conspicuous or unsightly construction details that envision the appearance of a respiratory mask. By adapting the technical features and benefits of a respiratory protective device, while maintaining the outer appearance of a fashionably acceptable garment, those among the general public who are self-conscious about wearing conspicuous attire can be provided comfortable and effective protection.

Because the inner panel is concealed from view, it can be standardized with materials, filters, and devices that form the respiratory portion which best perform to provide comfort and protection for the wearer, without concern for aesthetics. Concealing the inner panel, the outer panel is fully adaptable to multiple embodiments that have the appearance of fashion or technical clothing, and can complement any attire or activity. For example, a lightweight mesh fabric inner panel that has breathability and wicking properties is standardized and used to assemble the components of the respiratory portion; while the outer panel fabric is varied to suit warm or cold weather, athletic or business attire, or fashion trends, without compromising filtering effectiveness.

### BRIEF DESCRIPTION OF THE DRAWINGS

FIG. 1 is a perspective view of an embodiment of the protective garment, shown in partial cutaway view, with the inner panel shown in phantom view, and with the inner panel components shown in exploded view.

FIG. 2 is a side view of an embodiment of the protective garment in the donned position, shown in partial cutaway view, with the inner panel shown in phantom view, and with the outer panel and inner panel components shown in cross-sectional view taken along the vertical line of symmetry.

FIG. 3 is a side view detail of an embodiment of the protective garment in the donned position, with the outer panel and inner panel components shown in cross-sectional view taken along the vertical line of symmetry.

FIG. 4 is a frontal view of an embodiment of the protective garment in the donned position, with the components of the inner panel shown in phantom view.

FIG. 5 is a frontal view of an embodiment of the protective garment in the doff position, with the components of the inner panel shown in phantom view.

FIG. 6 is a frontal view of a one-piece rectangular scarf embodiment of the protective garment.

FIG. 7 is frontal view of a one-piece rectangular scarf embodiment of the protective garment in the donned position.

FIG. 8 is a rearward view of a one-piece rectangular scarf embodiment of the protective garment in the donned position.

FIG. 9 is a frontal view of a two-piece rectangular scarf embodiment of the protective garment.

FIG. 10 is frontal view of a two-piece rectangular scarf embodiment of the protective garment in the donned position.

FIG. 11 is a rearward view of a two-piece rectangular scarf embodiment of the protective garment in the donned position.

The illustrations are for simplicity and clarity and have not necessarily been drawn to scale. Dimensions of elements in the figures may be exaggerated relative to other elements to help improve the understanding of the present invention.

### DETAILED DESCRIPTION OF THE INVENTION

Referring now to the drawings wherein the showings are for purposes of illustrating a present embodiment of the invention only, and not for the purposes of limiting the same.

Protective inner panel 100 is sufficient in size to surround the face and neck. Projections 118 and 120 (FIG. 3) are formed at the locations of the nose and chin to seal and project respiratory portion 122 away from the mouth and nostrils. Assembled and attached to inner panel 100 are outer filter 104, inner filter 108, nose clip 110, nose pad 112, and chin seal 114 to form respiratory portion 122 at the nose/mouth region. Inner panel 100 is made of stretch or knit fabric to fit comfortably around the face and neck, and to secure respiratory portion 122 over the nose/mouth region. The preferred embodiment of inner panel 100 is a soft, lightweight, and breathable fabric to be worn in all seasons. Fabric in the preferred embodiment contains moisture wicking/hydrophobic polyester or nylon, but can be made of other technical fabrics, or natural fabrics, such as wool or cotton.

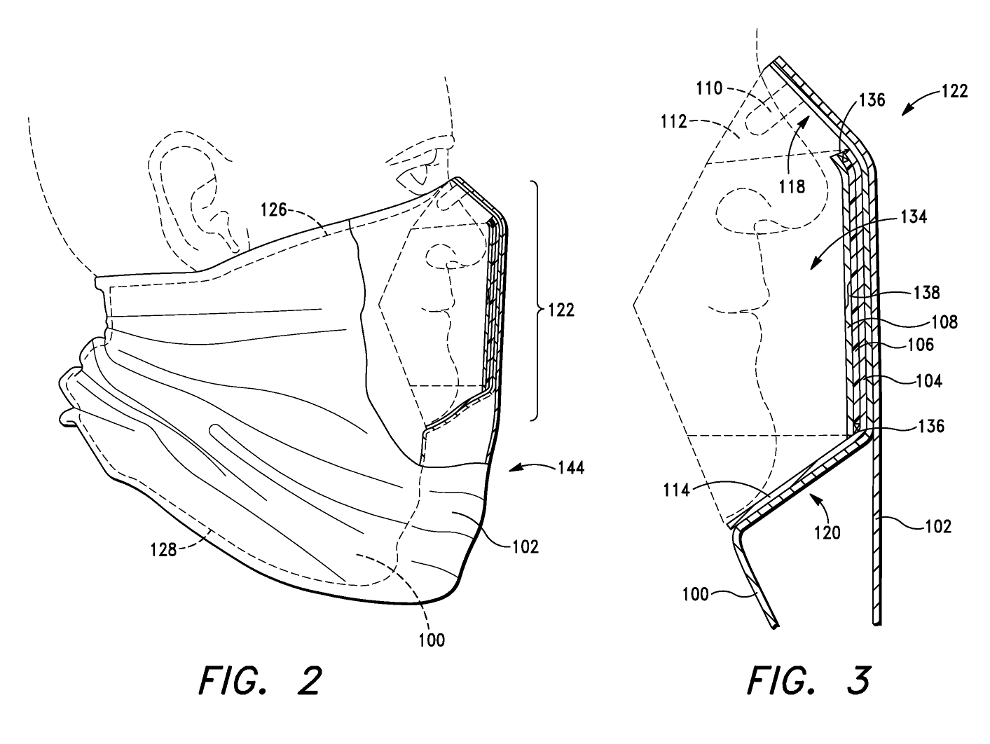

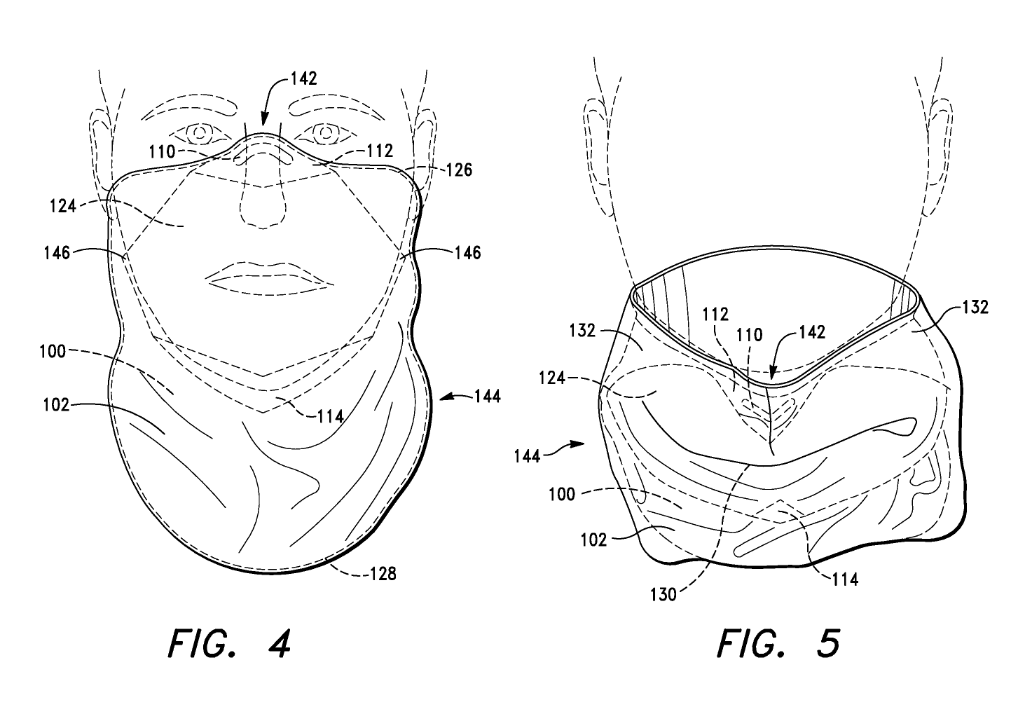

Outer panel 102 is sufficient in size to cover and conceal inner panel 100 and fit comfortably around the face and neck. Outer panel 102 is attached to upper edge 126 (FIGS. 2 and 4) of inner panel 100, and can additionally be attached to bottom edge 128 of inner panel 100. Outer panel 102 can be made from any stretch or knit fabric selected for use in warm or cold temperatures, or for other technical, protective, or aesthetic purposes.

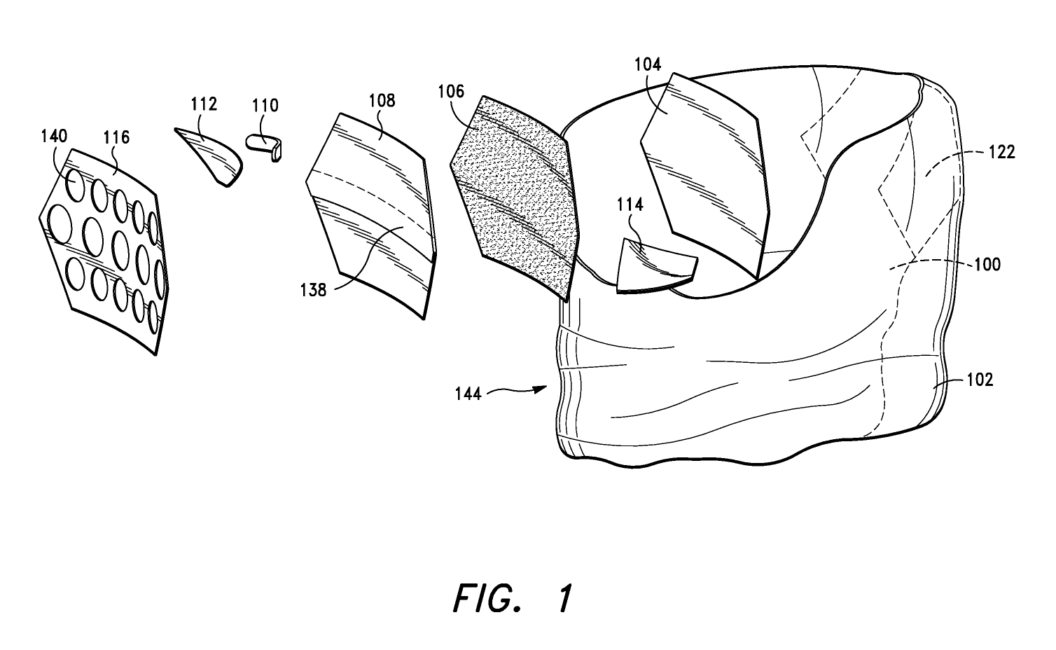

Inner filter 108 (FIGS. 1 and 3) is attached along the perimeter to outer filter 104 to form seam 136 (FIG. 3) to form a pocket. Inner filter 108 is sufficient in size to allow space 134 for breathing, and to cover the nose/mouth region. Filter 108 is made of non-stretch or woven fabric to provide structure to support a specialized middle filter 106 and also aid in filtering hazards and irritants. Fabric in the preferred embodiment of filter 108 is moisture wicking/hydrophobic so not to absorb moisture in the form of exhaled breath and perspiration. Filter 108 has a flap 138 or slots to install, remove or replace filter 106 depending on the need and activity of the wearer, the filter condition, or to launder the protective garment without damaging specialized filter 106.

Outer filter 104 is attached along the perimeter to inner filter 108 to form seam 136 to form a pocket. Outer filter 104 is sufficient in size to allow space 134 for breathing, and to cover the nose/mouth region. Filter 104 is made of non-stretch or woven fabric to provide structure to support specialized middle filter 106 and also aid in filtering hazards and irritants. Fabric in the preferred embodiment of filter 104 is moisture wicking/hydrophobic, however other fabrics are possible.

Middle filter 106 is sized to be inserted in the pocket formed by inner and outer filters 108 and 104. Middle filter 106 is sufficient in size to allow space 134 for breathing, and to cover the nose/mouth region. Filter 106 is a selectable and removable specialized filter to reduce inhalation of gases, odors, and/or particulates. Use of an activated carbon cloth filter 106 is preferred to be bonded or laminated to another fabric for durability. Other filters 106 can include, but are not limited to HEPA, N95 or N99, or multiple layer nanofiber filters.

Optional and removable filter support frame 116 (FIG. 1) is sized to be inserted in the pocket formed by inner and outer filters 108 and 104. Frame 116 requires holes 140 or other sufficient air passages if the size of frame 116 approximates the interior dimensions of the pocket formed by filters 108 and 104. Frame 116 is shaped to form a radius or angle opposite the nose and mouth to maintain breathing space 134 during periods of high air velocity. Frame 116 can be made of any material suitable to maintain filter assembly 124 (FIG. 4) away from the nostrils and mouth, such as plastic or polyester sheeting or film.

Nose clip 110 is made of material sufficiently flexible to be pre-shaped by hand to fit the wearer; and sufficiently rigid to retain shape unless deliberately altered. Nose clip 110 is sufficient in length so that the clip ends rest comfortably at the sides of the nose (FIGS. 3 and 4); and further sufficient in length to direct nose pad 112 to seal at the gaps between the nose and cheekbones. Nose clip 110 is void of sharp edges and does not irritate the neck and chin of the wearer when protective garment 144 is placed down around the neck (FIG. 5). Nose clip 110 rests low enough so that glasses may be worn. The present embodiment nose clip 110 is lead free soft temper aluminum, however other materials may be used that can be sized appropriately, pre-formed, and retain shape.

Nose pad 112 is sufficient in thickness to pad the area between the skin and nose clip 110; and sufficient in length to seal the gaps between the nose and cheekbones. Nose pad 112 is made of closed-cell, non-porous, or other suitable material which prevents unfiltered air from by-passing filter assembly 124. The present embodiment nose pad 112 is hypoallergenic closed-cell padding, however other materials may be used that appropriately pad the skin and seal the gaps between the nose and cheekbones.

Chin seal 114 is sized to cover the area of chin projection 120 which is not covered by filters 104, 106, and 108. Chin seal 114 is made of closed-cell, non-porous, or other suitable material which prevents unfiltered air from by-passing filter assembly 124.

To close the natural gaps that form between the nose and cheekbones when protective garment 144 is placed in position across the nose of the wearer, pre-formed nose clip 110, attached to closed-cell nose pad 112, is attached to inner panel 100. Nose clip 110 is custom shaped to the wearer in advance of employing protective garment 144 and is sufficiently rigid to retain the custom shape unless deliberately altered by the wearer. This sealing of the gap between the nose and cheekbones is also necessary to prevent the fogging of glasses as the wearer exhales.

The preferred method to custom shape nose clip 110 is to bend by-hand nose clip 110 over a cylindrical object, such as a dowel or finger, in which the diameter of the object is slightly larger than the width of the bridge of the wearer's nose. Nose clip 110 is pre-formed around the object such that nose clip 110 will rest comfortably on the wearer; and nose pad 112 will seal at the bridge and sides of the nose, and at the gaps between the nose and cheekbones. Because nose clip 110 retains a custom shape, respiratory portion 122 stays in place and will not shift or rotate out of place with the movement and activity of the wearer.

To further fit respiratory portion 122 to the nose of the wearer, projection 118 is formed at the nose portion of inner panel 100 so that nose clip 110, attached to nose pad 112, is closely aligned parallel to the ridge of the nose of the wearer. Nose projection 118 is formed by a fabric dart, or other known methods to shape the fabric so that the nose portion of inner panel 100, when placed in position, conforms to and seals the gaps around the nose of the wearer.

A second projection 120 is formed to close the gap between the chin and inner panel 100. Chin projection 120 is formed by a fabric dart, or other known methods to shape the fabric at a downward angle toward and below the chin. Projection 120 is overlapped by chin seal 114 to seal and prevent unfiltered air from passing through projection 120 and bypassing filter assembly 124. Alternately, chin projection 120 may be covered by a filter portion so that inhaled air passes through a filter or filters.

Inner and outer filters 108 and 104, attached along perimeter seam 136, which form a pocket to contain middle filter 106, are made of non-stretch or woven fabric. Protective garments in the present art, in which the filter portion is made of stretch or knit fabric, allow the filter portion to stretch over the nose and mouth region and therefore increase the distance between the filter fibers, thereby decreasing filter effectiveness. Furthermore, if a filter pocket is made of stretch or knit fabric and permitted to stretch around the nose and mouth region, the filter pocket could increase to a size greater than the inserted filter; allowing the filter to migrate within the pocket and permit inhaled air to bypass the filter.

To further fit the wearer and form a seal at the cheeks, inner and outer filters 108 and 104 (and inserted filter 106) taper from the top and bottom vertices to endpoints 146 (FIG. 4) along the horizontal line of symmetry. The shape of filters 108 and 104 in the present embodiment is hexagonal (FIG. 1), with the top and bottom sides greater in length than the remaining four sides. The greater length of the top and bottom sides provides for sufficient filter material to form breathing space 134 and also seal at the cheeks of the wearer. When respiratory portion 122 is applied, filter assembly 124 seals and tapers to the areas below the cheekbone and above the jawline.

By sizing and shaping non-stretch or woven fabric for inner and outer filters 108 and 104; constructing form-fitting projections 118 and 120 in the areas of the nose and chin; and attaching chin seal 114, pre-formed nose clip 110, and closed-cell nose pad 112, protective garment 144 maintains dimensions and effective sealing at respiratory portion 122, regardless of the facial contours, movement, or activity of the wearer. While the present embodiment is an effective example, variations of the components of respiratory portion 122 are possible which still perform to prevent airborne hazards and irritants from bypassing protective filters.

Breathing space 134 in the present embodiment is formed by nose and chin projections 118 and 120 at respiratory portion 122, which are sufficient in length to project filter assembly 124 away from the mouth and nostrils; thus preventing inner filter 108 from making direct contact with the mouth and nostrils. Space 134 provides comfort, ability to talk, prevents the transfer of lipstick or lip balm, and reduces the accumulation of moist exhaled breath. Space 134 also increases the effectiveness of respiratory portion 122 by increasing the utilized surface area of filter assembly 124.

Pre-formed nose clip 110, attached to nose pad 112, forms nose index 142 (FIGS. 4 and 5). Index 142 permits the wearer to instantly and unambiguously locate and center respiratory portion 122 in the protective position at the nose and mouth region. By grasping upper portion 132 (FIG. 5) and raising protective garment 144 to the bridge of the nose, index 142 self-locates and positions respiratory portion 122 without further effort by the wearer. The wearer does not waste time locating the center of respiratory portion 122, ear loops, or other attachments when donning protective garment 144; or readjusting nose clip 110 or a wire each time respiratory portion 122 is applied. There are no tie straps, ear loops, or other devices to get caught in the wearers hair or clothing, or interfere with headwear, such as a helmet. Index 142 rests low enough so that glasses may be worn. The ability of protective garment 144 to rapidly deploy overcomes the problem of the general public not always knowing when protection will be needed from the unpredictable appearance of hazards and irritants; unlike workplace environments when the need for protection is by comparison more predictable and therefore protective clothing can be donned in advance of exposure.

Because there are no ear loops or other fixed attachments to remove, the wearer can instantly remove respiratory portion 122 from the protective position. The fabric used for outer panel 102, inner panel 100, and filter assembly 124 has sufficient flexibility and drape to provide the ability of protective garment 144 to fold and compress comfortably and attractively when placed below the chin; or fully compressed around the base of the neck.

Protective garment 144 is further specifically formed, shaped, and void of devises of construction or rigid media to allow respiratory portion 122 to instantly collapse 130 (FIG. 5) in the doff position. By tapering filter assembly 124 to endpoints 146 along the horizontal line of symmetry, the wearer has the ability to tactilely locate the furthest points of filter assembly 124 and, by gently tugging, respiratory portion 122 will collapse 130 along the horizontal center as the wearer lowers protective garment 144 to the doff position.

A pocket formed by inner and outer filters 108 and 104, attached along perimeter seam 136, provides access to insert and remove specialized middle filter 106, thereby permitting filter 106 to be replaced when no longer effective; removed when not needed or to launder protective garment 144; replaced with a different type of filter 106; or to insert a combination of filters 106 depending on the activity of the wearer. The ability to layer multiple filters 106 within the pocket is possible. Inner filter 108 has overlapping sections of material to form flap 138, thereby providing access to the pocket. Other methods known in garment manufacturing to create or access a pocket or sleeve to install a specialized filter 106 are possible.

The inner and outer filters 108 and 104 which form the pocket are made of non-stretch or woven fabric with low breathing resistance. Multiple layers of filter material with low breathing resistance provide more comfortable breathing, yet effectively reduce air velocity and increase filtration surface area to aid particulate capture and gas adsorption. Respiratory filters with high breathing resistance, although effective for protection, can be uncomfortable due to difficulty breathing and moisture accumulation. Said filters are unlikely to be worn by public engaged in activity that does not require specified protection or high filtration, even in circumstances where protection could be beneficial. The filter pocket formed by inner and outer filters 108 and 104, with low breathing resistance, provides for a specialized middle filter 106 to be installed with low or high breathing resistance and corresponding levels of filtration, depending on the need or circumstances of the wearer, or filtration technologies available.

Specialized middle filters 106 can be selected for use with the protective garment 144 for the ability of the filter 106 material to fold and collapse, and therefore does not require removal from the pocket in order to place protective garment 144 comfortably down and around the neck when not needed; thereby supporting rapid deployment by the wearer. Furthermore, filter 106 materials can be selected and choices provided to consumers based on the specific hazards and irritants, or level of hazards and irritants desired to be protected against. For example, an activated carbon filter 106 may be used to adsorb chemical vapors and odors, while a particulate filter 106, such as HEPA or N95, may be used to prevent inhalation of small particulates. The specialized filter 106 pocket therefore makes protective garment 144 fully adaptable to the present and future needs of consumers.

As filter technologies are developed and discovered, new specialized filters 106 can be introduced and made available to pre-existing protective garments 144. In addition, in urgent circumstances, the filter pocket can serve to support any available filter 106 material, which may be shaped to fit inside the pocket, therefore providing indefinite use of protective garment 144 in urgent situations, such as natural or manmade disasters where respiratory protection is urgently needed.

Pocket access to remove middle specialized filter 106 provides protective garment 144 can be machine laundered without filter 106 installed. This eliminates the need for special washing procedures or the inability to launder protective garment 144 due to filters 106 that are permanently attached. For example, an activated carbon embodiment of filter 106, commonly used in respiratory protection, should not be laundered with household laundry detergent as the chemicals in the detergent will be adsorbed by the carbon, significantly reducing its effectiveness.

The pocket is further capable of accepting, when needed, a removable filter support frame 116, which will prevent filter assembly 124 from being pushed inward and against the mouth and nostrils during periods of activity when high air velocity is a factor, such as windy weather conditions, riding a bicycle or motorcycle, or downhill skiing. Frame 116 also provides some protection from small debris and insects hitting the nose and mouth. Frame 116 may also be used to increase breathing space 134, filtering surface area, or mated to a specialized filter 106.

To form and maintain the seal of the non-stretch respiratory portion 122 over the nose and mouth region, the remaining portion of inner panel 100 is made of stretch or knit fabric. The stretch or knit fabric allows inner panel 100 to comfortably form fit to the size and dimensions of the face and neck, and creates tension between the back of the neck and respiratory portion 122 at the face of the wearer. The resulting tension, with the aid of form-fitting projection 118 at the nose portion of inner panel 100, and custom fitted nose clip 110 that retains shape, provide respiratory portion 122 is maintained over the nose and mouth region; eliminated the need for ear loops or other outwardly conspicuous devices to retain respiratory portion 122 in the donned position. Respiratory portion 122 comfortably remains in place, allowing the wearer to move the head in all directions and engage in physical and sporting activities without respiratory portion 122 falling down, thereby maintaining protection for the wearer. Other inconspicuous features can be added to enhance positional stability without compromising the appearance or performance of protective garment 144. Snaps, buttons, hook-and-loop, or other devices known to garment manufacturing may be used to tighten the fit of respiratory portion 122 depending on the desire and need of the wearer.

Protective garment 144 is designed to adapt to and provide immediate, comfortable, and effective protection from hazards and irritants often encountered by the general public, including: dust; vehicle and factory emissions; pollen; bacteria; viruses; spores; allergens; volatile organic compounds; chemical vapors; cigarette, pet, perfume and nuisance odors; wind, sun, and cold; insects; indoor/outdoor hazards and irritants, and/or other undesirable particles and/or gasses in the air. Protective garment 144 can also function to warm and humidify cold, dry air for those persons suffering from asthma or other respiratory conditions.

Much of the general public travels from one type of hazard or irritant environment to another throughout the course of a day. For example: a person may be exposed to exhaust fumes and dust while walking or bicycling to a public transportation access point; be exposed to people contagious with the cold or flu coughing and sneezing while aboard public transportation; ride an elevator with a person wearing strong perfume; enter a room or work area where chemical cleaners are in use; stand in line next to cigarette and garbage can odors; and be exposed to strong wind and cold while traveling home. As the time of year changes, so may the needed protection, such as from allergens and the sun in spring and summer. Protective garment 144 is therefore designed to be versatile and adaptable from one environment to another. The ability of protective garment 144 to rapidly deploy, cover the face and neck with seasonal fabrics, and support filters 106 that protect from both particles and gases, overcomes the problem of the general public not always knowing when, and what type of, protection will be needed from the unpredictable or varying appearance of hazards and irritants. This is in contrast to workplace or professional environments when the need and type of protection is by comparison more known and predictable, in which the appropriately selected protective clothing can be donned in advance of exposure.

The selected features and devices of protective garment 144 can take into consideration those persons with chemical sensitivities. In the present embodiment, nose clip 110 and attached nose pad 112 are made, respectively, of lead free food grade aluminum and hypoallergenic, neoprene-free padding. Furthermore, the carbon embodiment of removable middle filter 106 is made from 100% activated carbon cloth, which, in addition to being more effective at adsorption of chemical vapors than carbon particles woven into fabric, is naturally antimicrobial and antiviral; preventing the need for filter assembly 124 to be chemically treated to provide protection from bacteria and viruses. The aforementioned features of the design provide so that those persons seeking protection from exposure to chemical irritants are not in consequence directly exposing themselves to irritating chemicals.

By standardizing inner panel 100 with the aforementioned features and devices that perform to protect the wearer from hazards and irritants, protective garment 144 can be easily adapted to multiple outer panel 102 embodiments to satisfy the functional and stylistic needs of the public. The features, effectiveness, and method of both applying respiratory portion 122 and placing respiratory portion 122 in the doff position can further remain the same regardless of the chosen style embodiment.

Embodiment examples of protective garment 144:

Sport scarf (not shown): A protective garment 144 with an inner panel 100 and without an outer panel 102. Although more conspicuous than other embodiments, the single panel sport scarf may be the preferred embodiment by persons seeking a technical style, or a fitted design, with minimal materials, to participate in sporting activities such as cycling, motorcycling, or downhill skiing. The single panel sport scarf can be adapted to other embodiments of protective garment 144 if a reduction in weight and material is desired.

For embodiments other than the sport scarf, an outer panel 102 is attached to upper edge 126 of inner panel 100, and can additionally be attached to bottom edge 128 of inner panel 100. Outer panel 102 does not attach to, and therefore does not take the shape of, the devices and contours of respiratory portion 122; For example, projection 120 formed at the chin. Outer panel 122 therefore covers and conceals the protective devices of inner panel 100, and has the natural drape, shape, and appearance of a commonly recognizable scarf.

Tube scarf (FIGS. 1-5): A protective garment 144, with an inner panel 100 and outer panel 102 in the embodiment of a tube scarf, also known as a neck gaiter.

Cowl scarf (not shown): A protective garment 144, with an inner panel 100 and a lengthened outer panel 102, closed to form a loop, typically worn close to the neck in the embodiment of a cowl scarf.

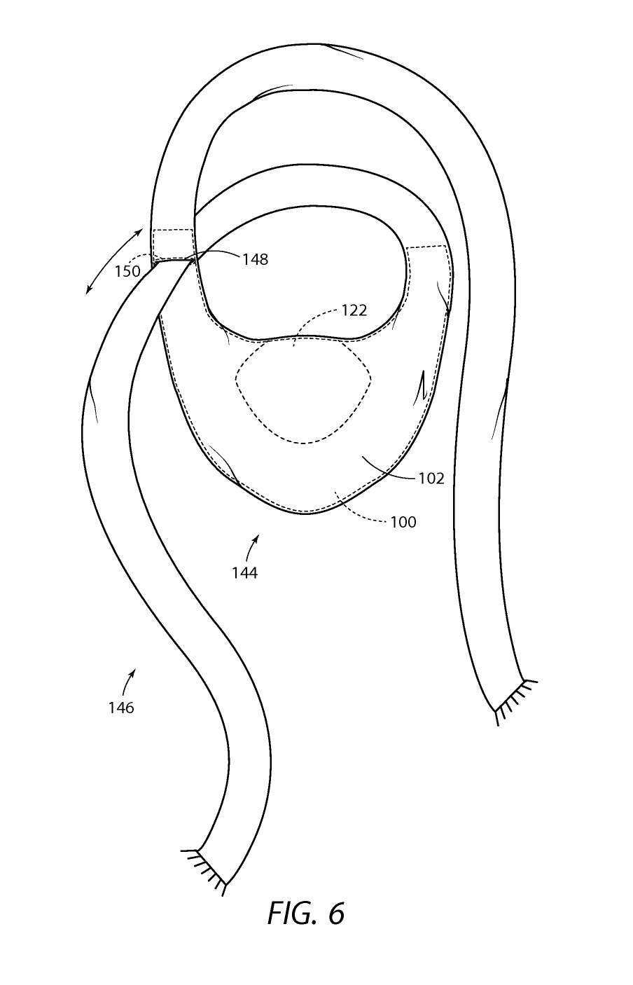

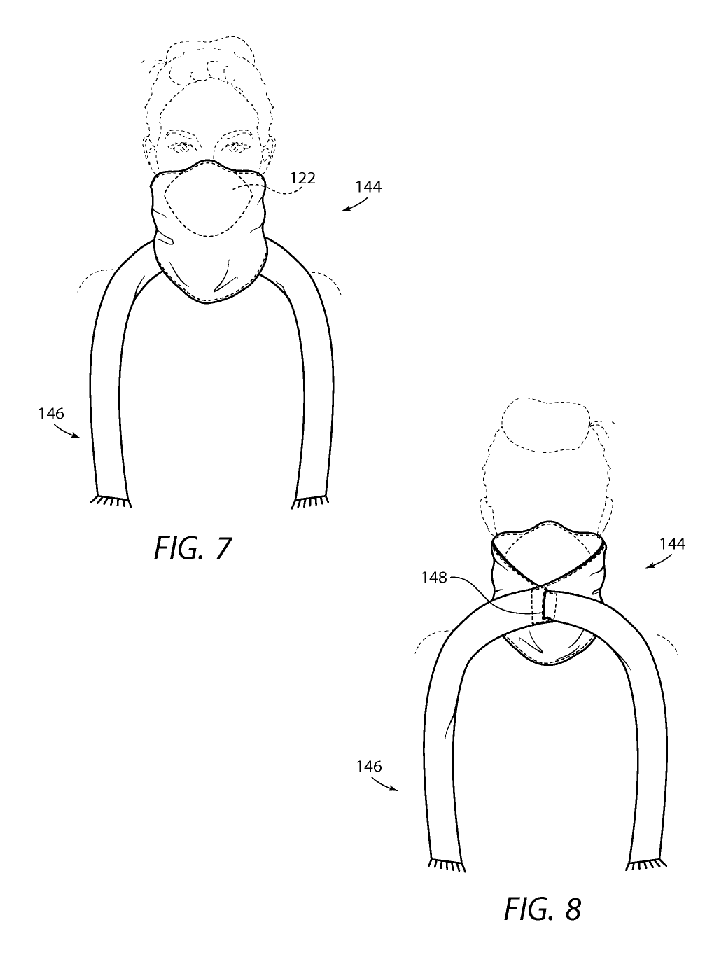

Rectangular scarf (FIGS. 6-8): A protective garment 144, with an inner panel 100 and a lengthened outer panel 102 in the embodiment of a common rectangular scarf 146.

Infinity scarf (not shown): A protective garment 144, with an inner panel 100 and a lengthened outer panel 102, closed to form a loop, typically sufficient in size to twist and wrap multiple times, in the embodiment of an infinity scarf.

An example of a method to form protective garment 144 in the embodiment of a cowl, infinity, or rectangular scarf 146: The protective inner panel 100 and attached outer panel 102 are not joined opposite respiratory portion 122 to form a tube. Beyond the dimensions of inner panel 100, outer panel 102 continues in length sufficient to form what is known as a cowl, infinity, or rectangular scarf 146 (for the cowl and infinity scarf embodiments, the scarf ends will later be attached to form a loop). A hole or slot 148 is formed on one end of inner panel 100 and attached outer panel 102, so that the lengthened cowl, infinity, or rectangular scarf 146 embodiment portion of outer panel 102 on the other end may pass through slot 148. Slot 148 is sized so that the embodiment portion can pass through slot 148, yet with enough friction so that the embodiment portion does not pass through slot 148 without deliberate action by the wearer. A rigid material 150, such as plastic, may be inserted to support and retain the shape of slot 148. The wearer passes the embodiment portion through slot 148 to fix respiratory portion 122 in the donned position. Once a secure fit is achieved, the wearer may raise and lower respiratory portion 122 as with other embodiments of protective garment 144, without the need to readjust the embodiment portion through slot 148. When the wearer no longer needs the ability to rapidly don respiratory portion 122, the cowl, infinity, or rectangular scarf 146 embodiment portion may be pulled through slot 148 and loosened to the wearers' style and preference.

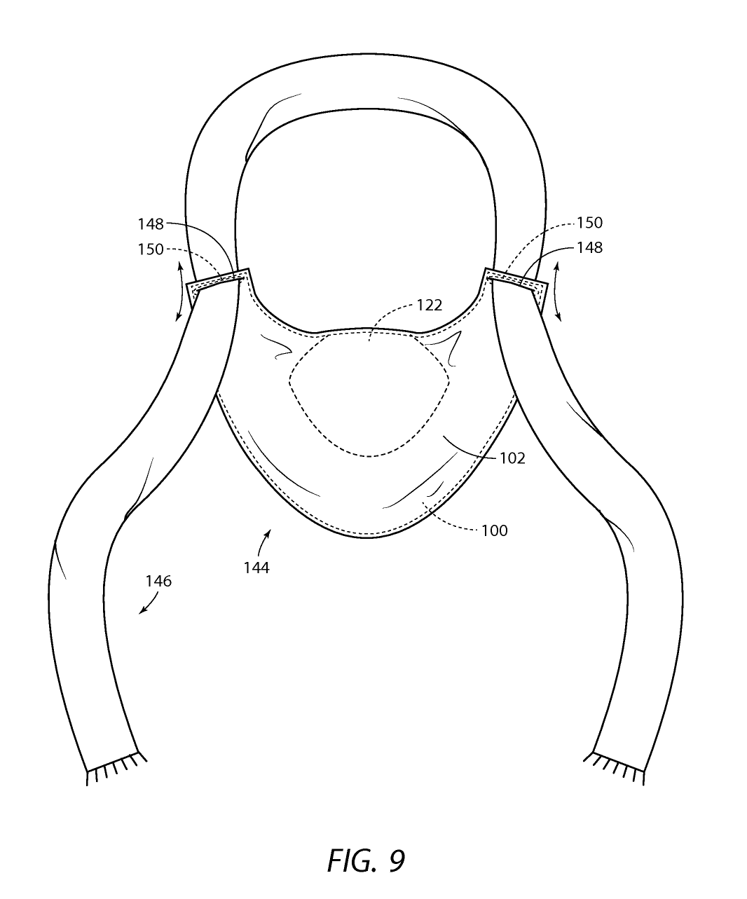

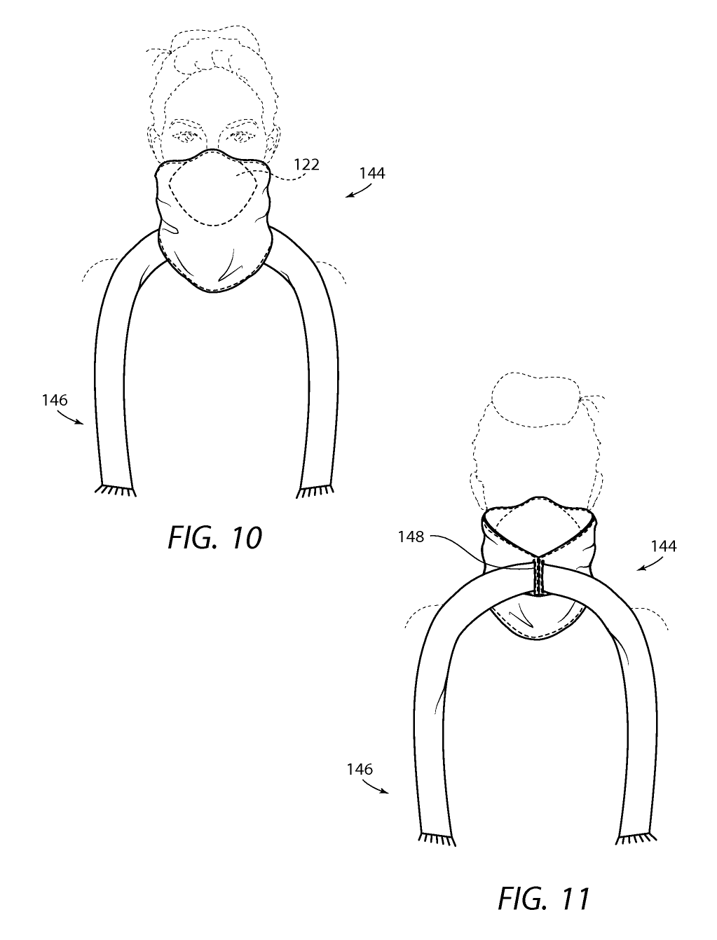

A further example of a method to form protective garment 144 in the embodiment of a cowl, infinity, or rectangular scarf 146 (FIGS. 9-11): The protective inner panel 100 and attached outer panel 102 are not joined opposite respiratory portion 122 to form a tube. Holes or slots 148 are formed on the opposite end of protective garment 144, so that the scarf embodiment may pass through slots 148 (for the cowl and infinity scarf embodiments, the scarf ends will later be attached to form a loop). Slots 148 are sized so that the scarf embodiment can pass through slots 148, yet with enough friction so that the scarf embodiment does not pass through slots 148 without deliberate action by the wearer. A rigid material 150, such as plastic, may be inserted to support and retain the shape of slots 148. The wearer passes the scarf embodiment through slots 148 to fix respiratory portion 122 in the donned position. Once a secure fit is achieved, the wearer may raise and lower respiratory portion 122 as with other embodiments of protective garment 144, without the need to readjust the scarf embodiment through slots 148. When the wearer no longer needs the ability to rapidly don respiratory portion 122, the cowl, infinity, or rectangular scarf 146 embodiment may be pulled through slots 148 and loosened to the wearers' style and preference.

The protective garment 144 embodiment examples of a cowl, infinity, or rectangular scarf 146, or, for example, the addition of a head cover, in which a portion or portions of the embodiment extend beyond the dimensions of inner panel 100; said portions can be made in a variety of sizes from any stretch or non-stretch fabric selected for use in warm or cold temperatures, or for other technical, protective, or aesthetic purpose.

The embodiments described are examples for illustrative purposes. Other protective garment 144 embodiments, features, and methods to attach or embody respiratory portion 122 are possible. For example, protective garment 144 could be separated opposite respiratory portion 122 and secured by means of hook-and-loop, or other temporary attachment as a means to don protective garment 144 without pulling it over the head. Another feature could be the addition of a snap or button opposite respiratory portion 122 to reduce the effective diameter of inner panel 100, and thereby further secure respiratory portion 122 to the wearer.

Protective garment 144 can further easily be altered and manufactured for the primary purpose of protection from weather elements, without necessarily including the features and devices to protect from other hazards and irritants. For example, protective garment 144 can be made with or without: outer filter 104, (use of) specialized middle filter 106, inner filter 108, and chin seal 114; and still perform as a rapidly deploying protective garment 144 to protect from sun, cold, wind, and coarse dust. As with other embodiments, the protective garment 144 will stay in place, provide breathing space 134, and prevent the fogging of glasses. For additional protection from sun, cold, wind, and dust, embodiments may include a head cover to form a hood, head scarf, or balaclava.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A protective garment, comprising:
a fabric panel configured to be secured around the face and neck of a user in a donned position and compressed down around the neck in a doff position, wherein said fabric panel is protective against at least one environmental irritant or weather element;
a projection formed on said fabric panel, wherein said projection is configured to conform to the nose of a user;
a clip, said clip being malleable to conform to the nose of a user, wherein said clip maintains shape unless deliberately altered; and
a pad configured to be positioned between said clip and nose of a user, wherein said pad forms a seal.

2. The protective garment of claim 1, wherein
at least one respiratory filter is attached to said fabric panel, wherein said respiratory filter is configured to cover the nose and mouth of a user when said respiratory filter is placed in a donned position; and
a second projection formed on said fabric panel, wherein said second projection is nearer the chin of a user and configured to maintain said donned respiratory filter away from the nostrils and mouth of a user.

3. The protective garment of claim 2, wherein
a second respiratory filter is attached to said respiratory filter, wherein said respiratory filter and said second respiratory filter form a pocket.

4. The protective garment of claim 3, wherein
at least one removable respiratory filter is received in said pocket.

5. The protective garment of claim 3, wherein
a removable frame is optionally inserted in said pocket, wherein said frame is configured to maintain said respiratory filters away from the nostrils and mouth of a user during periods of high air velocity.

6. The protective garment of claim 1, wherein
a generally larger outer fabric panel attached to first said fabric panel wherein said outer fabric panel does not adhere tightly to first said fabric panel such that said outer fabric panel conceals at least one feature of first said fabric panel.
